(19) United States
(12) Patent Application Publication
(10) Pub. No.: US 2019/0253153 A1
(43) Pub. Date: Aug. 15, 2019

(54) REDUCTION OF PDL PENALTY USING TRANSMIT SIGNAL PROCESSING ON SUB-CARRIER MULTIPLEXED SIGNALS

(71) Applicant: Infinera Corporation, Sunnyvale, CA (US)

(72) Inventors: Han Henry Sun, Ottaw (CA); David James Krause, Nepean (CA); Kuang-Tsan Wu, Ottawa (CA)

(21) Appl. No.: 16/158,224

(22) Filed: Oct. 11, 2018

Related U.S. Application Data
(60) Provisional application No. 62/570,667, filed on Oct. 11, 2017.

(51) Int. Cl. H04B 10/61; H04B 10/516; H04B 10/532; H04J 14/06

(52) U.S. Cl. CPC H04B 10/6162; H04J 14/06; H04B 10/532; H04B 10/5161

(57) ABSTRACT

Consistent with the present disclosure, a transmitter is provided that include a modulator and a laser. The modulator is driven based on outputs from a digital signal processor (DSP), such that the modulator outputs a modulated optical signal including a plurality of subcarriers. Each subcarrier includes an x pol component and a y pol component, but certain subcarriers may have an effective x pol and y pol rotations compared to other subcarriers. The amount of rotation may be determined by a polarization rotation circuit that supplies inputs to the DSP (alternatively the polarization rotation circuit may be part of the DSP). Accordingly, regardless of the orientation of PDL in an optical link, certain subcarriers may have lower overall Q (a parameter related to the signal-to-noise ratio (SNR)) while others may have a higher Q, such that the average Q over all the subcarriers in a modulated optical signal is higher than if each subcarrier has the same x pol and y pol orientations. In one example, a PDL penalty (reduction in Q due to the PDL, for example) may be reduced by 0.5 dB and, in other examples, the PDL penalty may be reduced by 1.0 dB. Overall improved SNR for the modulated optical signal including a plurality of subcarriers may also be achieved.

This application claims priority under 35 U.S.C. § 119 to U.S. Provisional Patent Application No. 62/570,667, filed on Oct. 4, 2017, the entire content of which is incorporated by reference herein in its entirety.

Polarization multiplexed (PM) quadrature phase shift keying (QPSK) and PM-m-quadrature amplitude modulation (QAM, m being an integer greater than or equal to 4) are known modulation formats employed in optical coherent detection systems. In such systems, light is modulated to carry data on two orthogonal polarizations, referred to as Transverse Electric, TE polarization (also referred to herein as the “x pol” or “x polarization”), and Transverse Magnetic, TM polarization (also referred to herein as the “y pol” or “y polarization”). As such polarization multiplexed optical signal propagate along an optical fiber communication path, the TE polarization component may experience different loss (or gain) than the TM polarization component. Such loss may be referred to as polarization dependent loss (PDL). For example, optical couplers, Bragg gratings, arrayed waveguide gratings (AWGs), optical multiplexers and demultiplexers, and other optical components provided along the optical communication path to carry or manipulate the TE and TM components may impart a different loss to the TE component than to the TM component of the optical signal. In addition, erbium doped fiber amplifiers (EDFAs), which may also be provided along the optical communication path, may impart more gain to one polarization component relative to the other polarization components so that the transmitted signal experiences polarization dependent gain.

Typically, after transmission over long distances and through multiple optical amplifiers and other optical components, such as after transmission over a distance of 2000 km and traversing through 25 EDFAs and multiple add-drop multiplexing elements, the optical signals may experience PDL that is statistically time-varying. Since the PDL in such a link changes with time, the link may be characterized by the average PDL (or mean PDL) measured in dBs. A poor link may have 2 dB of mean PDL, for example. Since the PDL is statistical, sometimes the PDL can be significantly more than the mean value, and for 2 dB mean, the instantaneous PDL may be as high as 6 dB, for example.

Typically, at the receive end of an optical communication path, decision devices (e.g., devices or circuitry in a receiver that can determine whether a received bit is 0 bit or a 1 bit) may be provided to detect the transmitted data carried by the TE and TM components. Even if the receiver can correct or compensate for a large instantaneous PDL, such as that noted above, the noise at the decision device receiving the TE components may differ than the noise at the decision device receiving the TM component. As a result, significantly different bit error rates (BERs) may be observed in connection with TE compared to the TM component in the coherent receiver.

Accordingly, there is a need for an optical communication system that can correct or compensate for PDL.

### SUMMARY

Consistent with an aspect of the present disclosure, a transmitter is provided that comprises a laser, and a modulator that provides an optical output based on light received from the laser, such that based on the optical output, the transmitter outputs a modulated optical signal including a first subcarrier and a second subcarrier. The first subcarrier has a first x polarization component and a first y polarization component, and the second subcarrier has a second x polarization component and a second y polarization component. The transmitter also includes a polarization rotation circuit that generates a first representation in an electrical domain of a rotation of the first x polarization and a second representation in the electrical domain of a rotation of the first y polarization, such that the modulator provides the optical output based on the first and second representations.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the present disclosure and together with the description, serve to explain the principles of the present disclosure.

### BRIEF DESCRIPTION OF THE DRAWINGS

FIG. 1a illustrates a system consistent with an aspect of the present disclosure;

FIG. 1b illustrates an example of subcarriers consistent with an aspect of the present disclosure;

FIG. 2 illustrates details of an example of polarization circuitry shown in FIG. 1;

FIG. 3 illustrates details of an example of a filter circuit shown in FIG. 2;

FIG. 4 shows details of an example of a receiver equalizer circuit shown in FIG. 1;

FIG. 5 illustrates details of an example of a filter circuit shown in FIG. 4;

FIGS. 6a-6c show examples of x pol (polarization) and y pol orientations and corresponding Q values associated with each consistent with an aspect of the present disclosure;

FIGS. 7a and 7b show examples of subcarrier x pol and y pol orientations and corresponding Q values consistent with a further aspect of the present disclosure;

FIG. 8 illustrates plots of average Q vs PDL angle consistent with an additional aspect of the present disclosure;

FIGS. 9a and 9b illustrate Poincare sphere representations of the x pol and y pol orientations shown in FIGS. 7a and 7b;

FIG. 10 illustrates plots of Q vs time in connection with non-rotated x pol and y pol as well as an example of rotated x pol and y pol corresponding to the representation shown in FIG. 7b;

FIG. 11a shows plots of maximum Q-minimum Q vs Q for different x pol and y pol orientations; and

FIG. 11b shows plots of average Q vs. PDL for different x pol and y pol orientations.

### DESCRIPTION OF THE EMBODIMENTS

Consistent with the present disclosure, a transmitter is provided that include a modulator and a laser. The modulator is driven based on outputs from a digital signal processor (DSP) and a polarization rotation circuit, such that the modulator outputs a modulated optical signal including a plurality of subcarriers. Each subcarrier includes an x pol component and a y pol component, but certain subcarriers may have an associated representation in the electrical domain of x pol and y pol rotation compared to other subcarriers. The amount of rotation may be determined by a polarization rotation circuit that supplies inputs to the DSP (alternatively the polarization rotation circuit may be part of the DSP). Accordingly, regardless of the orientation of PDL in an optical link, certain subcarriers may have lower Q (a parameter related to the signal-to-noise ratio (SNR)) while others may have a higher Q, such that the average Q over all the subcarriers in a modulated optical signal is higher than if each subcarrier has the same x pol and y pol orientations. In one example, a PDL penalty (reduction in Q due to the PDL, for example) may be reduced by 0.5 dB and, in other examples, the PDL penalty may be reduced by 1.0 dB. Overall improved SNR for the modulated optical signal including a plurality of subcarriers may also be achieved.

Reference will now be made in detail to the present exemplary embodiments of the present disclosure, examples of which are illustrated in the accompanying drawings. Wherever possible, the same reference numbers will be used throughout the drawings to refer to the same or like parts.

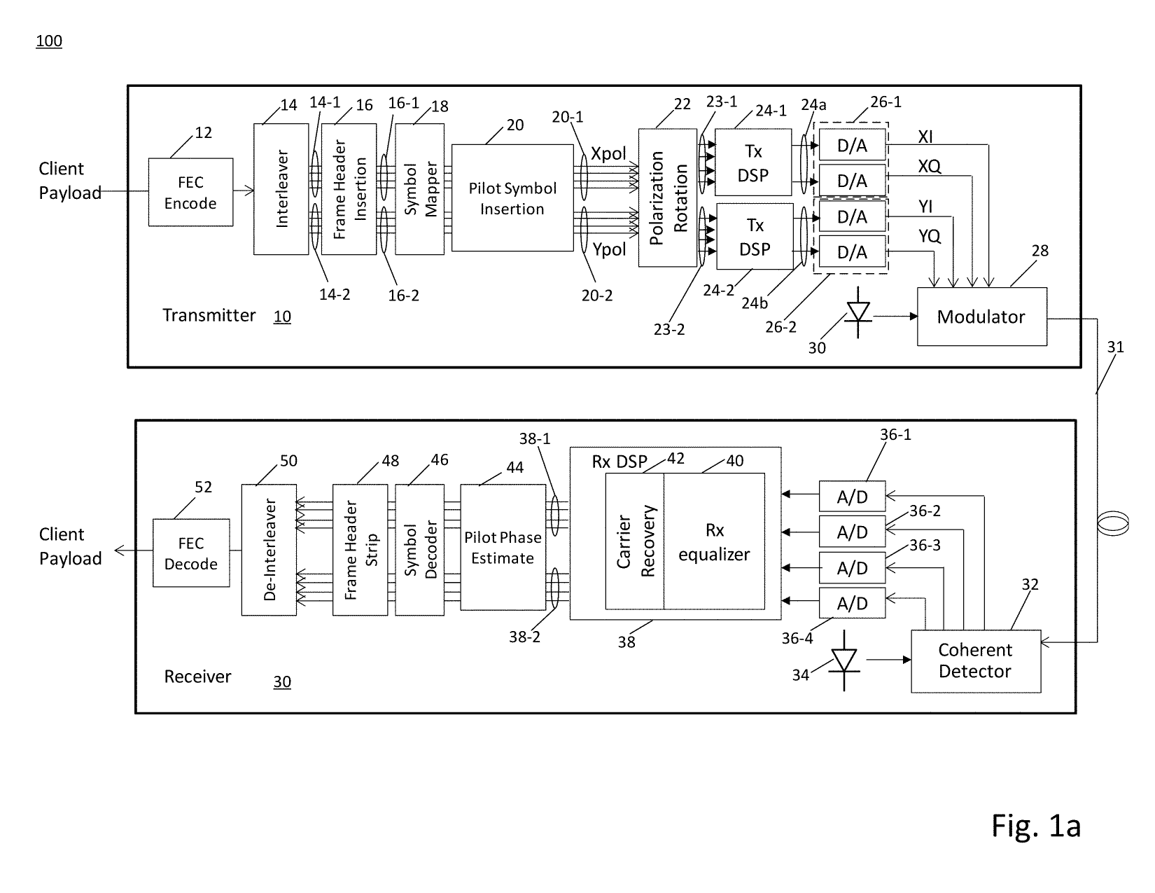

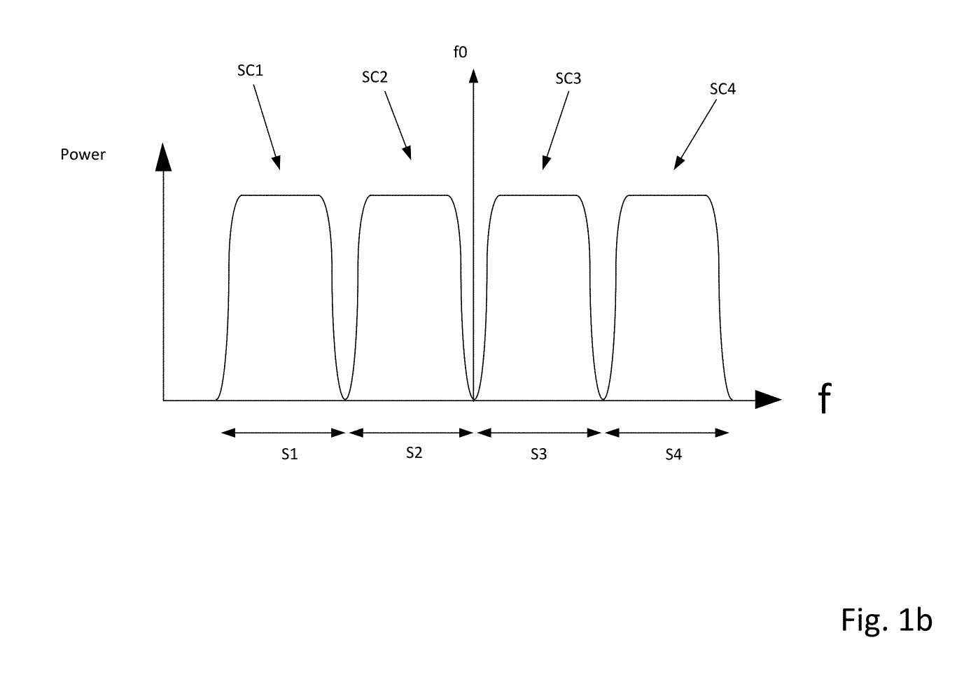

FIG. 1 illustrates an example of system 100 consistent with the present disclosure. System 100 includes polarization rotation circuit 22, which may be provided in the transmitter. As discussed in greater detail below, polarization circuit 22 may effectively rotate the x pol and y pol of each subcarrier to thereby achieve an overall improved Q and SNR for the modulated optical signal.

As shown in FIG. 1, optical system 100 may include a transmitter 10 and a receiver 30. Transmitter 10 may include forward error correction (FEC) encoder circuit 12 that receives a client payload or data and outputs encoded data, which may be interleaved by interleaver circuit 14 to provide two groups (14-1 and 14-2) of four outputs each in this example. Each output in group 14-1 corresponds to a respective x pol component of a subcarrier and each output in group 14-2 corresponds to a respective y pol component of a subcarrier. In this example, four subcarriers are generated, although it is understood that in other examples more or fewer optical subcarriers may be output, each having x and y pol components.

As further shown in FIG. 1, frame insertion circuitry 16 may be provided to insert header bits or bytes into each output within groups 14-1 and 14-2 to define frames of data, wherein the header bits may define the beginning of each frame. In addition, bits may also be provided to define the end of each such frame. Frame header insertion circuit 16, in turn, provides two groups of framed outputs 16-1 and 16-2 to symbol mapper 18, which maps sequences of bits in each output of groups 16-1 to 16-2 to particular values, which correspond to a symbol to be output from the transmitter to the receiver. each symbol may correspond to a point in constellation on an in-phase/quadrature plane. Next, symbol mapper 18 supplies two groups of four outputs each to pilot symbol insertion circuitry 20, which inserts additional symbols into each output within each group for purposes of determining phase in receiver 30. Pilot symbol insertion circuitry supplies two groups of outputs 20-1 and 20-2, each including four outputs, to polarization rotation circuit 22, as noted above. As further noted above, each output in the first group of outputs 20-1 corresponds to an x pol of a respective subcarrier and each output in the second group of outputs 20-2 corresponds to a y pol of a respective subcarrier. As discussed in greater detail below, polarization rotation circuit 22 may include filters having multiplier circuits that multiply in-phase and quadrature components of the x pol and y pol of each subcarrier to thereby effect a representation of a rotation in the electrical domain of the x pol and y pol of at least one of the subcarriers. Polarization rotation circuit 22 may be proved separate from or included in one or both of DSPs 24-1 and 24-2. In addition, polarization rotation circuit 22 and processing circuitry included in DSPs 24-1 and 24-2 may be included in the same processor or DSP.

As further shown in FIG. 1, a first group of four outputs 23-1 from polarization rotation circuit 22 is supplied to DSP 24-1 and a second group of four outputs 23-2 from polarization rotation circuit 22 is supplied to DSP 24-2. Each DSP 24-1 and 24-2 supplies output pairs 24-a and 24-b corresponding to modulator drive signals in digital form. Outputs 24-a and 24-b are supplied to corresponding pairs of digital-to-analog circuits (D/A) 26-1 and 26-2. D/A circuit 26-1 converts the received digital signals 24-a into corresponding analog or drive signals XI, XQ, which correspond to the in-phase and quadrature components, respectively, of the x pol of each subcarrier. Similarly, D/A circuit 26-2 converts received digital signals 24-b into corresponding analog or drive signals YI, YQ, which correspond to the in-phase and quadrature components, respectively, of the y pol of each subcarrier.

As further shown in FIG. 1, drive signals XI, XQ, YI, and YQ may be based on output from polarization rotation circuit 22 and may be supplied to modulator 28, which also receives light from laser 30, which may be a semiconductor laser, such as a distributed feedback (DFB) or distributed Bragg reflector (DBR) laser. The modulator may include nested Mach-Zehnder (MZ) modulators that generate modulated optical signals. Each of the modulated optical signals output from the MZ modulators may have the same, e.g., x pol, polarization. Accordingly, a polarization rotator may also be provided to rotate the polarization of one of the optical signals to be y pol, and a polarization combiner or multiplexer may further be provided to multiplex the y pol signal with the x pol signal. As noted above, the resulting modulated optical signal output from the modulator 28 may include a plurality, e.g., four subcarriers, each having x pol and y pol components, and each such component be modulated to carry data.

FIG. 1b illustrates an example of subcarriers SC1 to SC4 that may be output from modulator 28. As shown in FIG. 1b, subcarriers SC1 to SC4 may not spectrally overlap with one another and may be, for example, Nyquist subcarriers, which may have a frequency spacing equal to or slightly larger than the individual subcarrier baud-rate.

As further shown in FIG. 1b, subcarriers may have spectra or bandwidths, S3 (subcarrier SC3) and S4 (subcarrier SC4) above frequency f0, which may correspond to a center frequency of the laser (e.g., laser 508). In addition, subcarriers may have spectra or bandwidths, S1 (subcarrier SC1) and S2 (subcarrier SC2) below frequency f0.

Transmission and detection of optical subcarriers is further described in United States Patent Application Publication No. 2014/0092924, the entire content of which is incorporated by reference herein in its entirety.

The modulated optical signal including the subcarriers may propagate along an optical fiber link 31, which may include multiple optical amplifiers and/or other device or components, such as optical add/drop multiplexer, and couplers. Each subcarrier may be modulated by modulator 28 in accordance with the same modulation format, such as QPSK or m-QAM (e.g., 8-QAM, 16-QAM, 64-QAM, and 256-QAM). After propagation along link 31, coherent detector 32 in receiver 30 may receive a modulated optical signal, which may be a distorted or impaired optical signal based the modulated optical output from transmitter 10. Coherent detector 32 also receives light from local oscillator laser 34, which may have the same or similar construction as laser 30 described above. Coherent detector 32 may include 90-degree optical hybrid circuits that mix the received optical signal with the light output from local oscillator laser 34. The resulting mixing products may be provided to photodiodes, such as balanced photodiodes in coherent detector 32. The photodiodes, in turn, generate electrical signals which may be amplified by transimpedance amplifiers (TIAs), subject to automatic gain control (AGC), and output to analog-to-digital (A/D) converters 36-1 to 36-4. A/D converters 36-1 to 36-4, in turn, generate digital samples based on the received outputs from coherent detector 32. The digital samples are fed to a receiver DSP 38, which includes equalizer circuit 40 and carrier receiver circuit 42. DSP 38 supplies two groups 38-1, 38-2 of four outputs each, the first group of outputs 38-1 corresponds to the data carried by the x pol of each subcarrier, and the second group of outputs 38-2 corresponds to the data carried by the y pol of each subcarrier.

Output groups 38-1 and 38-2 are provided to phase estimating circuit 44, which estimates or determines the phase associated with each subcarrier based on the pilot symbols inserted by circuit 20 in transmitter 10. The outputs of pilot phase estimate circuit 44 are provided to a symbol decoder circuit, which outputs bit sequences corresponding to each symbol carried by the modulated optical signal output from transmitter 10. Frame header strip circuit 48, removes the header bits and any other frame defining bits from the outputs of symbol decoder circuit 46, and the outputs of frame header strip circuit 48 are de-interleaved in circuit 50, which provides an output to FEC decoder 52. Next, FEC decoder 52, decodes the outputs of de-interleaver 50 and may perform error correction to output a copy of the client payload or data that was supplied to transmitter 10.

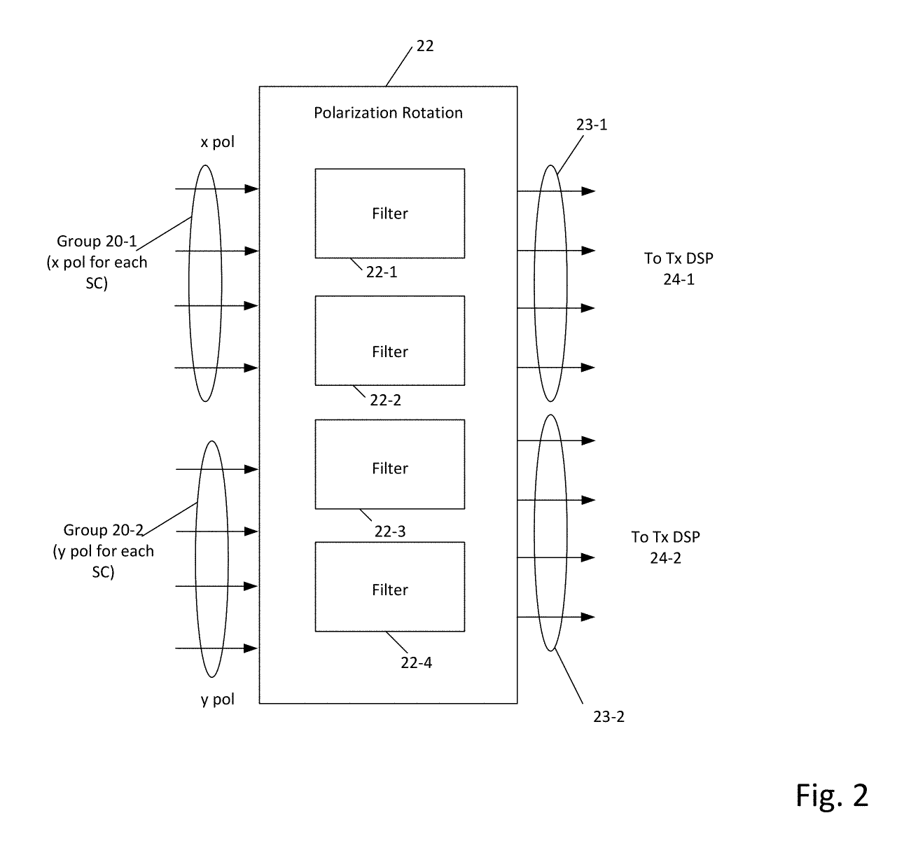

FIG. 2 shows polarization rotation circuit 22 in greater detail. Polarization rotation circuit 22 includes a plurality of filters 22-1 to 22-4, each of which receiving a respective output from group 20-1 (corresponding to the x pol of a respective subcarrier) and a respective output from group 20-2 (corresponding to the y pol of a respective subcarrier). As discussed in greater detail below, at least some of filters 22-1 to 22-4 may perform a matrix multiplication on the respective subcarrier x pol and y pol components supplied thereto thereby effectively rotate or generate in the electrical domain a representation of a rotation of the x pol and y pol components of at least one of the subcarriers.

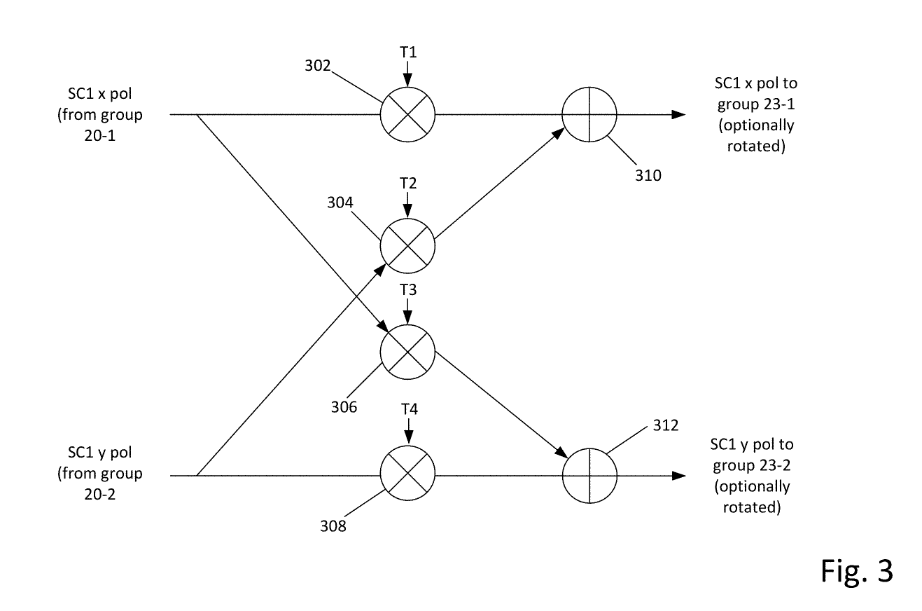

FIG. 3 shows filter 22-1 in greater detail for carrying out such matrix multiplication. It is understood that remaining filters 22-2 to 22-4 may have the same or similar structure as filter 22-1 but will receive other outputs from circuit 20 than the outputs received by filter 22-1.

Filter 22-1 may include four multiplier circuits 302, 304, 306, and 308. x pol data associated with one of the outputs in group 20-1 is multiplied by a coefficient T1 by multiplier 302, and multiplier 306 multiplies the x pol data by coefficient T3. In addition, y pol data associated with one of the outputs in group 20-2 is multiplied by a coefficient T4 by multiplier 308, and multiplier 304 multiplies such y pol data by coefficient T2. Further, the product output from multiplier 302 is added to the product output from multiplier 304 in summing or adder circuit 310, and the resulting sum may be output as a representation in the electrical domain of a rotated x pol of one of the subcarriers. Alternatively, no such rotation may be applied. Moreover, the product output from multiplier 306 is added to the product output from multiplier 308 by adder or summer 312 to provide y pol data of one of the subcarrier that may be a representation in the electrical domain of a rotated y pol.

As described below, some the x pol and y pol of certain subcarriers may be rotated as noted above, whereas the x pol and y pol of other subcarriers may not be rotate or may be “aligned”, i.e., the x pol is aligned with x axis and the y pol is aligned with the y axis. Thus, certain filters, such as filters 22-1 and 22-3, may generate the representation of the rotation, while filters 22-2 and 22-4 may not generate such representation, but generate a representation of aligned x pol and y pol components instead. In addition, various matrices may be employed, as noted below with respect to Table 1.

Although a particular filter circuit is shown in FIG. 3, it is understood that other filters and other circuits may carry out the matrix multiplication described above or otherwise generate a representation in the electrical domain of a rotation of the subcarrier x pol and y pol. Such filters and circuits are also contemplated herein and are intended to be included by use of the term “filter” herein.

Returning to FIG. 1, the x pol filter outputs 23-1 may be supplied to DSP 24-1 and the y pol filter outputs 23-2 may be provided to DSP 24-2. Further processing and transmission may be carried out as described above.

It is noted that filters having the same or similar structure as that shown in FIG. 3 may also be provided in equalizer circuit 40 to correct for rotations to the x pol and y pol incurred during transmission along link 31. In addition, equalizer circuit 40 may also correct for any rotations imparted by polarization rotation circuit 22.

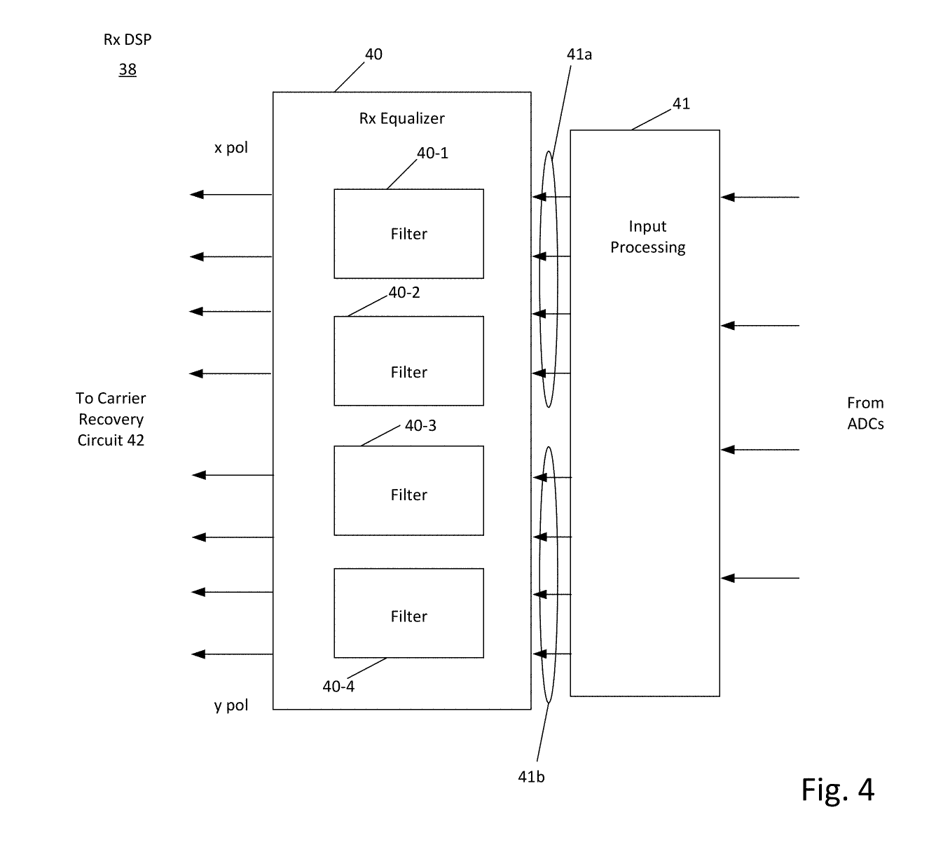

For example, as shown in FIG. 4, equalizer circuit 40 includes a plurality of filters 40-1 to 40-4, each of which receiving a respective output from group 41a (corresponding to the x pol of a respective subcarrier) and a respective output from group 41b (corresponding to the y pol of a respective subcarrier). As discussed in greater detail below, at least some of filters 40-1 to 40-4 may perform a matrix multiplication on the respective subcarrier x pol and y pol components supplied thereto to effectively rotate or generate a representation in the electrical domain of a rotation of the x pol and y pol components of at least one of the subcarriers. Output groupings 41a and 41b may be generated based on the digital samples output from the A/D converters circuits. In one example, the digital samples are fed to input processing circuitry (shown as circuitry 41 in FIG. 4), which may include circuitry for chromatic dispersion compensation or correction and circuitry, such as a demultiplexer that demultiplexes the subcarriers (in electronic form) into output groups 41a (including data associated with the x pol of each subcarrier) and 41b (including data associated with the y pol of each subcarrier) to equalizer 40.

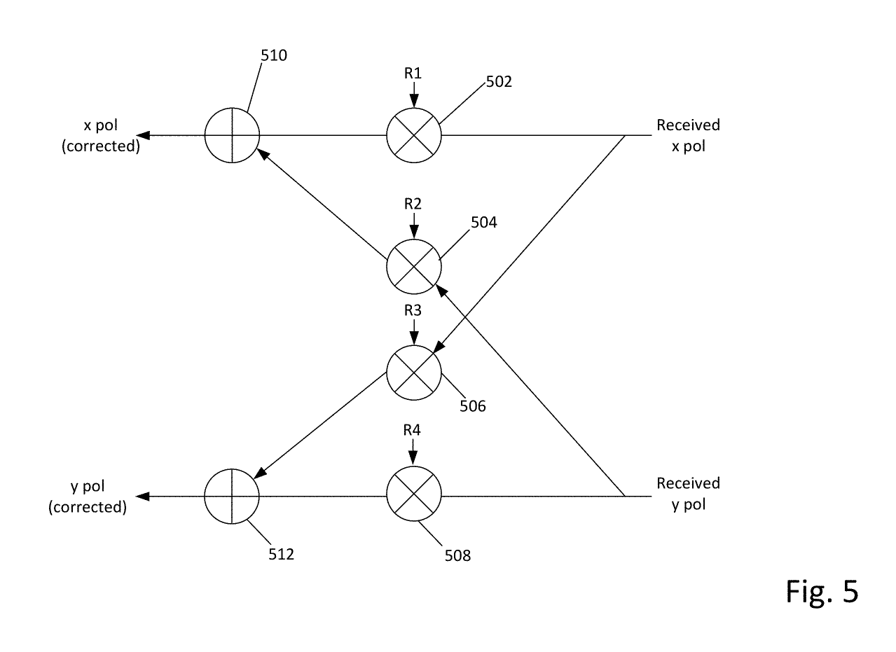

FIG. 5 shows filter 40-1 in greater detail for carrying out such matrix multiplication. It is understood that remaining filters 40-2 to 40-4 may have the same or similar structure as filter 40-1 but will receive other outputs from circuit 20 than the outputs received by filter 40-1.

Filter 40-1 may include four multiplier circuits 502, 504, 506, and 508. x pol data associated with one of the outputs in group 41a is multiplied by a coefficient R1 by multiplier 502, and multiplier 506 multiplies the x pol data by coefficient R3. In addition, y pol data associated with one of the outputs in group 41b is multiplied by a coefficient R4 by multiplier 508, and multiplier 504 multiplies such y pol data by coefficient R2. Further, the product output from multiplier 502 may be added to the product output from multiplier 504 in summing or adder circuit 510, and the resulting sum may be output as corrected x pol data of one of the subcarriers by effectively rotating or generating a representation in the electrical domain of a rotation of the polarization of the x pol by an amount equal or substantially equal to the rotation experienced by the x pol during propagation along link 31 and the rotation, if any, imparted by polarization rotation circuit 22. Moreover, the product output from multiplier 506 is added to the product output from multiplier 508 by adder or summer 512 to correct y pol data by effectively rotating or generating a representation in the electrical domain of a rotation of the y pol by an amount equal or substantially equal to the sum of the rotation incurred during propagation along link 31 and the rotation, if any, imparted by polarization rotation circuit 20.

Although a particular filter circuit is shown in FIG. 5, it is understood that other filters and other circuits may carry out the matrix multiplication described above or otherwise generate the representation in the electrical domain of the rotation of the x pol and y pol noted above. In addition, it is understood that coefficients R1 to R4 may be the same or different than coefficients T1 to T4.

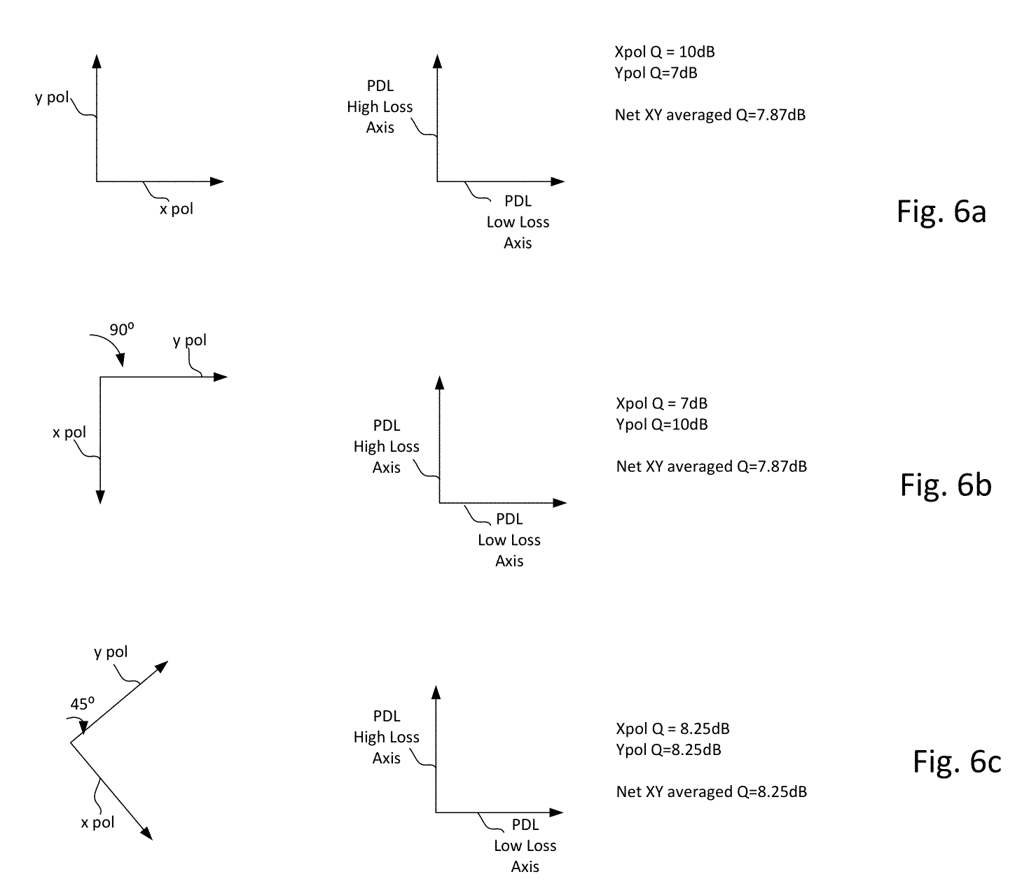

Selection of appropriate rotation angles consistent with the present disclosure will next be described with reference to FIGS. 6a-6c, 7a, 7b, 8, 9a, and 9b.

As shown in FIG. 6a, PDL typically has a low loss axis and a high loss axis that is orthogonal to the low loss axis. In this example, the high loss axis is along the y axis and the low loss axis is along the x axis. If a polarization multiplexed optical signal is transmitted in a link having PDL axes as shown in FIG. 6a, the y pol will be aligned with the high loss PDL axis, but the x pol is aligned with the low loss PDL x axis. Thus, in this example, although the x pol Q may be relatively high, the y pol Q is low, such that the average Q over the two polarization components is 7.87 dB. Similarly, if the x pol and y pol are rotated 90°, as in FIG. 6b, the y pol of the signal is aligned with the PDL low loss axis, but the x pol is aligned with the PDL high loss axis. Accordingly, the x pol Q is reduced to 7 dB, while the y pol Q is improved to 10 dB, but the average Q remains at 7.87 dB.

On the other hand, if the x pol and y pol are rotated by 45°, the y pol Q improves to 8.25 dB because the y pol has a component aligned with the low loss PDL axis, and, therefore y pol Q is increased. Although, the x pol, in this case, has a lower Q, because it has a component aligned with the low loss axis, the average Q, when both x pol and y pol are rotated to be 45° from the PDL low loss and high loss axes is 8.25 dB. Accordingly, the average Q improves by about 0.38 dB relative to the examples shown in FIGS. 6a and 6b in which one of either the x pol or the y pol is aligned with the low loss PDL axis.

The PDL low and high loss axes, however, rotate over time. That is, the axes are time variant. Accordingly, it is difficult to maintain the x pol and y pol orientation shown in FIG. 6c in a practical system. Consistent with the present disclosure, however, one subcarrier, e.g., subcarrier SC1 may include x pol and y pol components that are effectively rotated 45° relative to the x polarization axis and the y polarization axis, respectively, by filter 20-1, for example. A second subcarrier, SC3, may also include x pol and y pol components, but such components may remain aligned with the x and y axes, respectively. Put another way, the x pol and y pol of SC1 may be rotated 45° relative to the x pol and y pol of SC3.

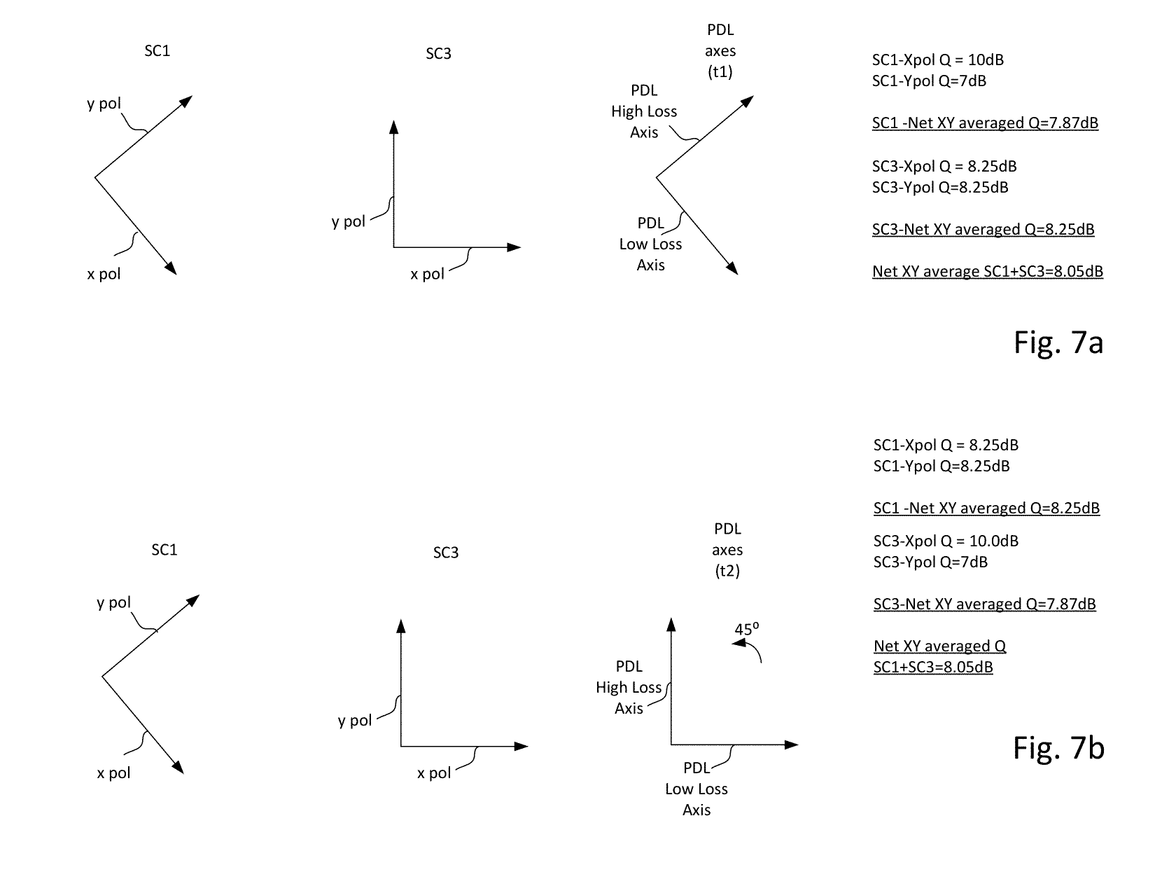

Accordingly, as shown in FIG. 7a, when the time varying PDL high and low loss axes are aligned with the y pol and x pol of subcarrier SC1 at an initial time t1, the average Q of SC1 is 7.87 dB, which is similar to the examples discussed above in connection with FIGS. 6a and 6b. However, both the x pol and the y pol of subcarrier SC3 are oriented at 45° relative to the high and low loss PDL axes. Therefore, the average Q of SC3 is 8.25 dB, as in the example shown in FIG. 6c. Since SC1 and SC3 are included in the same modulated optical signal and are processed together, the average or system Q associated with SC1 and SC3 is 8.05 dB.

A similar result is obtained in FIG. 7b. Here, the PDL high and low loss axes have rotated at a later time t2 to be oriented at 45° relative to the high and loss loss axes shown in FIG. 7a. In FIG. 7b, although SC3 has the degraded average Q (instead of SC1 in FIG. 7a) because the x pol and y pol are aligned with the PDL low loss and high loss axes, respectively, x pol and y pol of SC1 in this example are both at 45° relative to the high and low loss PDL axes. Accordingly, the average system Q associated with SC1 and SC3 remains at 8.05 dB.

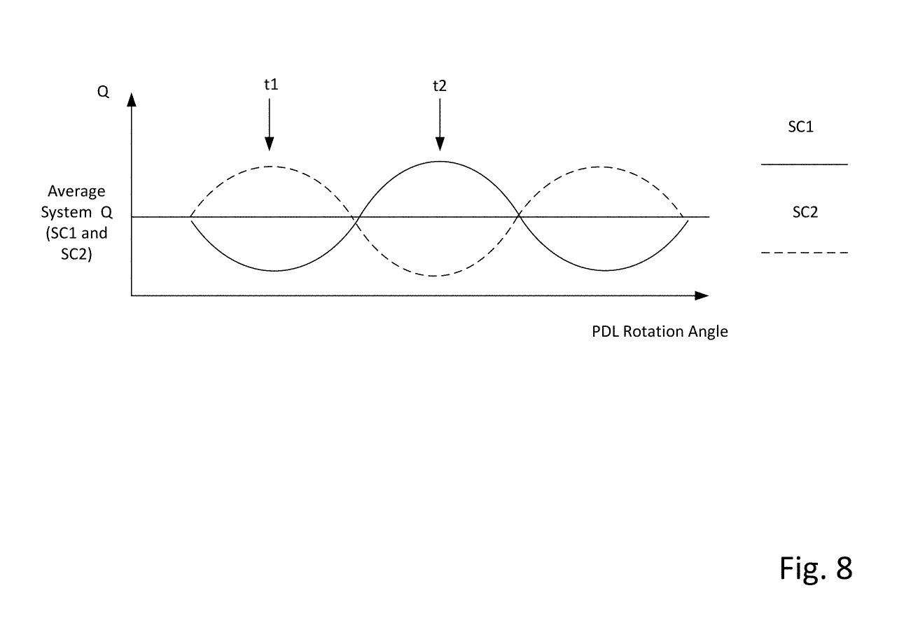

FIG. 8 shows plots of Q vs PDL rotation angle SC1 and SC3. As shown in FIG. 8, Q for both SC1 and SC3 may vary sinusoidally with the PDL rotation angle, but the Q plots for SC1 and SC3 are offset relative to one another by a PDL rotation angle of 90 degrees. Accordingly, as further shown in FIG. 8, the average system Q associated with SC1 and SC3 may remain substantially constant and at a higher value than what would be observed if x pol and y pol had the same orientation.

x pol and y pol of SC2 may be oriented in the same manner as that discussed above in regard to SC1, and SC4 may have the orientation noted above with respect with SC3, and the average system Q of SC1 to SC4 would be similar or the same as that noted above.

Table 1 lists the matrices (also referred to as “Jones rotation” matrices), which may be employed by filters 22-1 to 22-4 to realize the rotations described above.

TABLE 1

| Configuration | Aligned | 0/45° | | Tetrahedral | | |
|---|---|---|---|---|---|---|
| Subcarrier | 1-4 | SC2,4 | SC1,3 | SC1 | SC2 | SC3,4 |
| Jones Rotation | $[ \begin{matrix}1 & 0 \\ 0 & 1\end{matrix} ]$ | $[ \begin{matrix}1 & 0 \\ 0 & 1\end{matrix} ]$ | $\frac{1}{\sqrt{2}} [ \begin{matrix}1 & - 1 \\ 1 & 1\end{matrix} ]$ | $[ \begin{matrix}1 & 0 \\ 0 & 1\end{matrix} ]$ | $\frac{1}{2} [ \begin{matrix}1 & - \sqrt{3} \\ \sqrt{3} & 1\end{matrix} ]$ | $\frac{1}{4} [ \begin{matrix}- 1 \pm \sqrt{3} j & - 2 \sqrt{3} \\ 2 \sqrt{3} & - 1 ∓ \sqrt{3} j\end{matrix} ]$ |

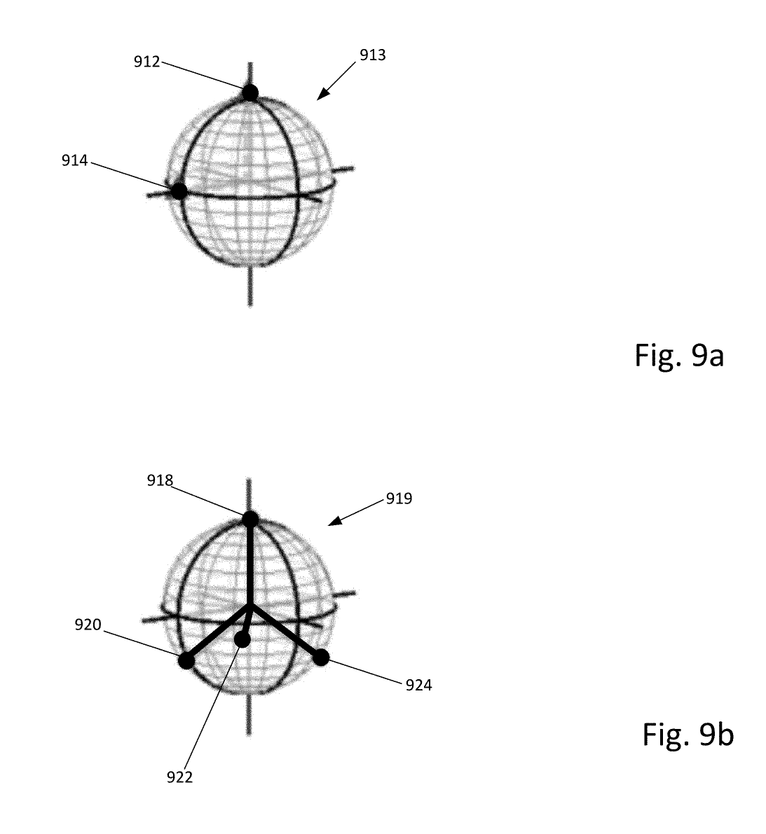

As shown in Table 1, the Jones rotation matrix for the aligned orientation corresponds to the x pol of each of subcarriers SC1 to SC4 being aligned along the same (x) axis, and y pol of each of these subcarriers being aligned along the same (y) axis. The same Jones rotation matrix may be applied to subcarrier SC2, as shown in FIGS. 7a and 7b, while the 45° rotation may be obtained by applying the Jones matrix rotation for SC1,3 in the column labeled 0/45°. A Poincare sphere representation of such 0/45° x pol and y pol orientations is shown in FIG. 9a, and a Poincare sphere representation in which the points on the sphere are equidistant from one another to form a tetrahedral is shown in FIG. 9b.

The matrix in Table 1 corresponding to SC2,4 in the column labeled “0/45” also corresponds to point 912 on the Poincare sphere 913 shown in FIG. 9a. In addition, the matrix in Table 1 corresponding to SC1,3 in the column labeled “0/45” also corresponds to point 914 in FIG. 9a.

In FIG. 9b, point 918 on Poincare sphere 919 corresponds to the “tetrahedral” matrix in Table 1 associated with SC1, and each of the remaining points 920, 922, and 924 is associated with a corresponding one of the matrices shown in Table 1, as well as a respective one of subcarriers SC2, SC3, and SC4. In connection with the example shown in FIG. 9b and the “tetrahedral” matrices included in Table 1, the real and imaginary parts of the x pol and y pol of each subcarrier are taken into account so that an overall system Q may remain relatively constant. It is noted that each of the tetrahedral matrices may be applied by a corresponding one of filters 22-1 to 22-4 of polarization rotation circuit 22.

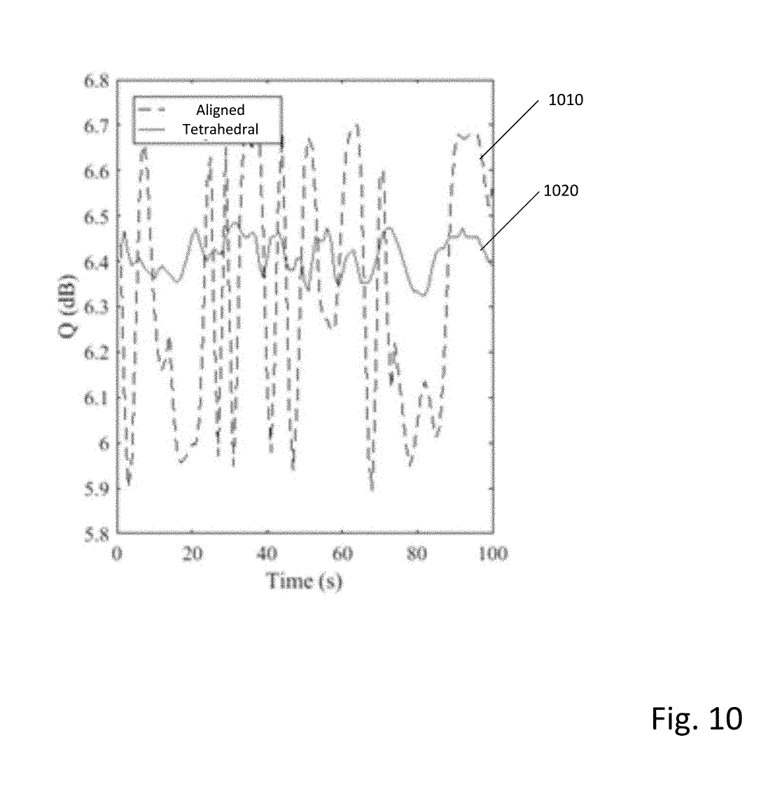

FIG. 10 shows a plot 1010 of system Q vs time for the “conventional” case in which the x pol components of SC1 to SC4 are aligned to the same x axis, and y pol components of SC1 to SC4 are aligned to the same y axis. As shown in FIG. 10, Q values associated with plot 1010 fluctuate considerably from a low of about 5.9 dB to a high of about 6.7 dB as the PDL angle changes over time. As noted above, such wide swings in Q may lead to reduced performance. As further shown in FIG. 10, however, plot 1020 corresponds to x pol and y pol orientations of SC1 to SC4 associated with the “tetrahedral” matrices. Here, Q values are confined to a limited range of about 6.4 to 6.5 regardless of changes in the PDL angle. Thus, spikes in Q to the low side, as well as sharp increases in Q, are not observed in connection with the subcarriers associated with plot 1020 and improved performance may be achieved.

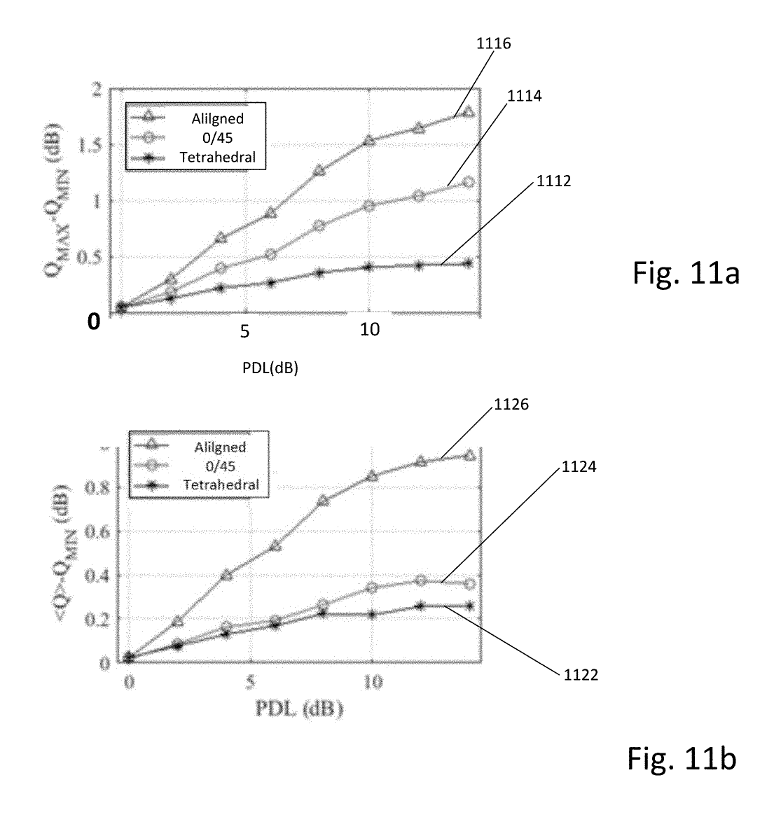

Further examples of improved performance that may be achieved with the present disclosure will next be described in connection with FIG. 11, which shows plots of Qmax-Qmin vs PDL of aligned x pol and y pol components of SC1 to SC4 (plot 1116), SC1 and SC3 having x pol and y pol orientations at 45° relative to the high and low loss PDL axes as noted above with respect to FIGS. 7a and 7b (plot 1114), and SC1 to SC4 having x pol and y pol polarizations based on the “tetrahedral” matrices listed in Table 1 (plot 1112). As shown in FIG. 11a, the smallest fluctuations in Q may be observed in connection with the tetrahedral matrices. In addition, reduced fluctuations are observed in connection with the 0/45 orientations noted above (see also Table 1) relative to the “aligned” orientations in which x pol and y pol are not rotated at the transmitter.

FIG. 11b shows plot of average Q-Q min vs PDL, which is an alternate expression for variations in Q. As in FIG. 11a, the best performance (smallest Q variation) may be observed in connection with the tetrahedral matrices of Table 1 (see plot 1122). In addition, reduced fluctuations (plot 1124) are observed in connection with the 0/45 orientations noted above (see also Table 1) relative to the “aligned” orientations in which x pol and y pol are not rotated at the transmitter (plot 1126).

Other embodiments will be apparent to those skilled in the art from consideration of the specification. It is intended that the specification and examples be considered as exemplary only, with a true scope and spirit of the invention being indicated by the following claims.

What is claimed is:

1. A transmitter, comprising:
a laser;
a modulator that provides an optical output based on light received from the laser, such that based on the optical output, the transmitter outputs a modulated optical signal including a first subcarrier and a second subcarrier, the first subcarrier having a first x polarization component and a first y polarization component, and the second subcarrier having a second x polarization component and a second y polarization component; and
a polarization rotation circuit that generates a first representation in an electrical domain of a rotation of the first x polarization and a second representation in the electrical domain of a rotation of the first y polarization, such that the modulator provides the optical output based on the first and second representations.

2. A transmitter in accordance with claim 1, wherein the polarization rotation circuit includes a plurality of filters.

3. A transmitter in accordance with claim 2, wherein at least one of the plurality of filters includes multiplier circuits that matrix multiply an input to provide the first and second representations.

4. A transmitter in accordance with claim 1, wherein the rotation of the first x polarization and the rotation of the first y polarization is 45°.

5. A transmitter in accordance with claim 1, wherein the polarization rotation circuit generates a third representation in the electrical domain of a rotation of the second x polarization and a fourth representation in the electrical domain of a rotation of the second y polarization.

6. A transmitter in accordance with claim 1, wherein the first representation is the same as the third representation and the second representation is the same as the fourth representation.

7. A transmitter in accordance with claim 1, wherein the first representation is different than the third representation and the second representation is different than the fourth representation.

8. A transmitter in accordance with claim 1, wherein the modulated optical signal includes third and fourth subcarriers.

9. A transmitter in accordance with claim 1, wherein at least one of the plurality of subcarriers is modulated in accordance with a quadrature phase shift keying (QPSK) modulation format.

10. A transmitter in accordance with claim 1, wherein at least one of the plurality of subcarriers is modulated in accordance with an m-quadrature amplitude modulation (m-QAM) modulation format, where m is an integer greater than or equal to four.

11. A transmitter in accordance with claim 1, wherein each of the first and second subcarriers is a Nyquist subcarrier.

12. A transmitter in accordance with claim 1, wherein an average Q of the first and second subcarriers is higher than an average Q when a representation of the first x polarization and a representation of the first y polarization are not rotated.

13. A system, comprising:
a transmitter, including:
a laser,
a modulator that provides an optical output based on light received from the laser, such that based on the optical output, the transmitter outputs a first modulated optical signal including a first subcarrier and a second subcarrier, the first subcarrier having a first x polarization component and a first y polarization component, and the second subcarrier having a second x polarization component and a second y polarization component, and
a polarization rotation circuit that generates a first representation in an electrical domain of a rotation of the first x polarization and a second representation in the electrical domain of a rotation of the first y polarization, such that the modulator provides the optical output based on the first and second representations; and
a receiver, that receives a second modulated optical signal based on the first modulated optical signal.

14. A system in accordance with claim 13, further including an equalizer circuit provided in the receiver, the equalizer circuit correcting a rotation of an x polarization in the second modulated optical signal, the rotation of the x polarization in the second modulated optical signal being based on a sum of a first rotation incurred by the second modulated optical signal propagating along an optical link and the first representation of the rotation of the x polarization.

15. A transmitter in accordance with claim 13, wherein the polarization rotation circuit includes a plurality of filters.

16. A transmitter in accordance with claim 15, wherein at least one of the plurality of filters includes multiplier circuits that matrix multiply an input to provide the first and second representations.

17. A transmitter in accordance with claim 13, wherein the rotation of the first x polarization and the rotation of the first y polarization is 45°.

18. A transmitter in accordance with claim 13, wherein the polarization rotation circuit generates a third representation in the electrical domain of a rotation of the second x polarization and a fourth representation in the electrical domain of a rotation of the second y polarization.

19. A transmitter in accordance with claim 13, wherein the first representation is the same as the third representation and the second representation is the same as the fourth representation.

20. A transmitter in accordance with claim 13, wherein the first representation is different than the third representation and the second representation is different than the fourth representation.

21. A transmitter in accordance with claim 13, wherein the modulated optical signal includes third and fourth subcarriers.

22. A transmitter in accordance with claim 13, wherein at least one of the plurality of subcarriers is modulated in accordance with a quadrature phase shift keying (QPSK) modulation format.

23. A transmitter in accordance with claim 13, wherein at least one of the plurality of subcarriers is modulated in accordance with an m-quadrature amplitude modulation (m-QAM) modulation format, where m is an integer greater than or equal to four.

24. A transmitter in accordance with claim 13, wherein each of the first and second subcarriers is a Nyquist subcarrier.

25. A transmitter in accordance with claim 13, wherein an average Q of the first and second subcarriers is higher than an average Q when a representation of the first x polarization and a representation of the first y polarization are not rotated.
